(19) United States
(12) Patent Application Publication
(10) Pub. No.: US 2018/0174293 A1
(43) Pub. Date: Jun. 21, 2018

(54) CRADLE DEFLECTION MITIGATION BY IMAGE INTERPOLATION

(71) Applicant: General Electric Company, Schenectady, NY (US)

(72) Inventors: Xiao Jin, Brookfield, WI (US); Adam Clark Nathan, Shorewood, WI (US); Steven Gerard Ross, Pewaukee, WI (US)

(21) Appl. No.: 15/380,725

(22) Filed: Dec. 15, 2016

(51) Int. Cl. G06T 7/00; G06T 3/40; G06T 11/60

(52) U.S. Cl. CPC G06T 7/0012; G06T 3/4007; G06T 11/60; G06T 2207/10081; G06T 2207/20221; G06T 2210/41; G06T 2207/10104; G06T 2207/30004

(57) ABSTRACT

The present disclosure relates to correcting misalignment of image data within an overlap region in acquired scan data. By way of example, systems and methods for applying a post-reconstruction interpolation are described to correct mis-registration of features within overlap regions in either sequentially acquired axial scans or single scan acquisitions.

### BACKGROUND

The subject matter disclosed herein relates to medical imaging and, in particular, to the compensation of deflection or sag of a table or patient support (e.g., a change in table inclination when extended) during medical imaging.

Non-invasive imaging technologies allow images of the internal structures or features of a patient to be obtained without performing an invasive procedure on the patient. In particular, such non-invasive imaging technologies rely on various physical principles, such as the differential transmission of X-rays through the target volume or the emission of gamma radiation, to acquire data and to construct images or otherwise represent the observed internal features of the patient.

Traditionally, medical imaging systems, such as a positron emission tomography (PET), computed tomography (CT), or single photon emission computed tomography (SPECT) imaging system or a combined or dual-modality imaging system (e.g., a CT/PET imaging system), include a gantry and a patient table. The patient table needs to be as transparent as possible to the radiation used to generate images, i.e., X-rays in a CT context and gamma rays in a PET context. As a result, the tables may be constructed of thin, composite materials which need to support several hundred pounds of weight. The patient table includes a patient support (e.g., cradle or pallet) that typically extends from the table into the gantry bore. However, due to the size and weight of the patient and the composition of the table, the vertical position of the patient may change with respect to the imaging gantry due to sagging or deflection of the table and the patient support when extended. This may lead to image artifacts or discrepancies, such as misalignment between adjacent images or image regions.

### BRIEF DESCRIPTION

In one embodiment, a method for correcting mis-alignment of image data is provided. In accordance with this method two or more reconstructed image frames are accessed. Adjacent image frames each have an overlap region corresponding to a respective region of a patient. For a respective pair of adjacent image frames the respective region is vertically displaced between a first image frame and a second image frame of the respective pair. An interpolation of a subset of each reconstructed image frame is performed such that each frame comprises an interpolated region and a non-interpolated region. The interpolated region of the second image frame includes the overlap region and the non-interpolated region of the first image frame includes the overlap region. The first image frame and the second image frame are joined at the overlap region to form an interpolated composite frame. The vertical displacement of the respective region is at least partially corrected in the interpolated composite frame.

In a further embodiment, an image processing system is provided. In accordance with this embodiment, the image processing system includes a processor configured to access or generate two or more reconstructed image frames and to execute one or more executable routines for processing the two or more reconstructed image frames; and a memory configured to store the one or more executable routines. The one or more executable routines, when executed by the processor, cause the processor to: access the two or more reconstructed image frames, wherein adjacent image frames each have an overlap region corresponding to a respective region of a patient, wherein for a respective pair of adjacent image frames the respective region is vertically displaced between a first image frame and a second image frame of the respective pair; perform an interpolation of a subset of each reconstructed image frame such that each frame comprises an interpolated region and a non-interpolated region, wherein the interpolated region of the second image frame includes the overlap region and the non-interpolated region of the first image frame includes the overlap region; and join the first image frame and the second image frame at the overlap region to form an interpolated composite frame, wherein the vertical displacement of the respective region is at least partially corrected in the interpolated composite frame.

In an additional embodiment, one or more non-transitory computer-readable media encoding executable routines are provided. In accordance with this embodiment, the routines, when executed by a processor, cause acts to be performed comprising: accessing two or more reconstructed image frames, wherein adjacent image frames each have an overlap region corresponding to a respective region of a patient, wherein for a respective pair of adjacent image frames the respective region is vertically displaced between a first image frame and a second image frame of the respective pair; performing an interpolation of a subset of each reconstructed image frame such that each frame comprises an interpolated region and a non-interpolated region, wherein the interpolated region of the second image frame includes the overlap region and the non-interpolated region of the first image frame includes the overlap region; and joining the first image frame and the second image frame at the overlap region to form an interpolated composite frame, wherein the vertical displacement of the respective region is at least partially corrected in the interpolated composite frame.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of an embodiment of a positron emission tomography (PET) imaging system in accordance with aspects of the present disclosure;

FIG. 2 is a perspective view of a PET/computed tomography (CT) imaging system having the PET imaging system of FIG. 1, in accordance with aspects of the present disclosure;

FIG. 3 depicts a sequence of two images depicting a patient being moved progressively through the bore of an imaging system and the increased deflection of the patient support when extended, in accordance with aspects of the present disclosure;

FIG. 4 depicts a pair of sequential image frames and a resulting composite or stitched image frame without deflection correction;

FIG. 5 depicts a pair of sequential image frames and a resulting stitched image frame with deflection correction, in accordance with aspects of the present disclosure;

FIG. 6 graphically depicts a function of interpolation magnitude in relation to axial slice number, in accordance with aspects of the present disclosure; and

FIG. 7 graphically illustrates vertical shifting of pixel intensity to achieve deflection correction within a slice, in accordance with aspects of the present disclosure.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present subject matter, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

As described herein, in certain instances medical imaging systems, such as a positron emission tomography (PET), a computed tomography (CT), or a single photon emission computed tomography imaging system or a combined or dual modality imaging system (e.g., a CT/PET imaging system), include a patient table that includes a patient support (e.g., cradle or pallet) that extends from the table into a gantry bore. However, due to the size and weight of the patient and the composition of the table, a vertical position of the patient relative may change with respect to the imaging gantry when the table (e.g., patient support) is extended due to sagging or deflection of the table and the patient support. Such deflection may result in artifacts or inconsistencies in generated images, such as misalignment between adjacent frames, which may deteriorate the quality of medical images.

By way of example, in sequentially acquired axial images or frames, an overlap region may be present between sequential frames such that both frames depict a common or shared region. Due to differences in the deflection of the patient support between images, however, the material depicted in the overlap region may be misaligned in the two frames. In accordance with the present approach, to compensate for misalignment in the overlap region between adjacent frames, a post-reconstruction interpolation is performed. In one implementation, the interpolation is a linear interpolation that is performed once, so the impact on image reconstruction speed is minimal. Though the present discussion and examples are generally presented in the context of a sequential axial frame acquisitions, the present approach may be equally applicable in a single scan context, such as where an acquisition is performed while slowly extending the patient support within the imaging bore of a scanner such that support deflection increases over the course of the acquisition.

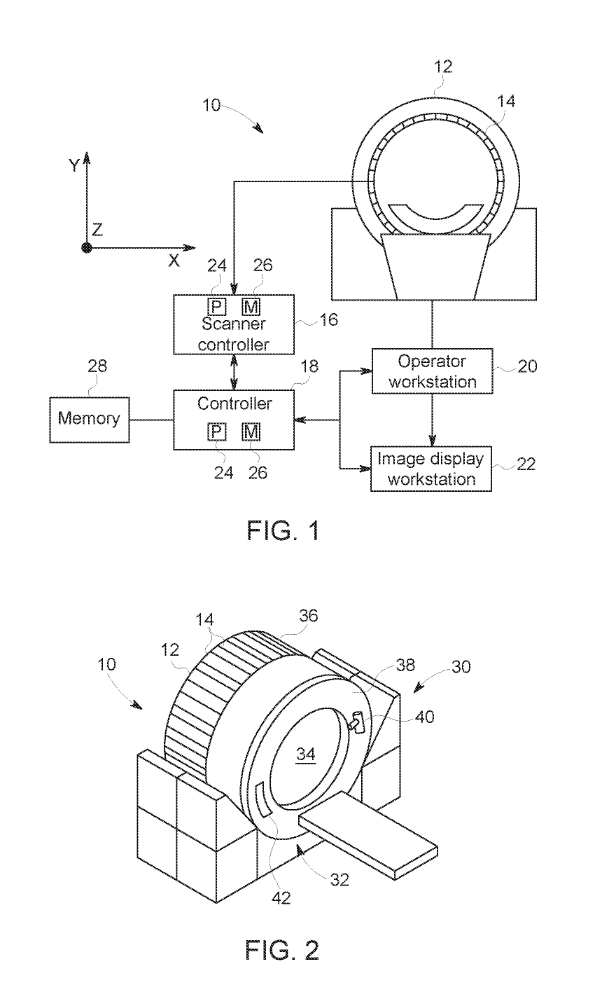

Although the following implementations are generally discussed in terms of a PET, SPECT, and CT/PET imaging system, the embodiments may also be utilized with other imaging system modalities (e.g., standalone CT, and so forth) that are subject to image discontinuities due deflection of the extended patient support. With the preceding in mind and referring to the drawings, FIG. 1 depicts a PET or SPECT system 10 operating in accordance with certain aspects of the present disclosure. The PET or SPECT imaging system of FIG. 1 may be utilized with a dual-modality imaging system such as a PET/CT imaging described in FIG. 2.

Returning now to FIG. 1, the depicted PET or SPECT system 10 includes a detector 12 (or detector array). The detector 12 of the PET or SPECT system 10 typically includes a number of detector modules or detector assemblies (generally designated by reference numeral 14) arranged in one or more rings, as depicted in FIG. 1. In practice, the detector modules 14 are used to detect radioactive emissions from the breakdown and annihilation of a radioactive tracer administered to the patient. By determining the paths traveled by such emissions, the concentration of the radioactive tracer in different parts of the body may be estimated. Therefore, accurate detection and localization of the emitted radiation forms a fundamental and foremost objective of the PET or SPECT system 10.

The depicted PET or SPECT system 10 also includes a scanner controller 16, a controller 18, an operator workstation 20, and an image display workstation 22 (e.g., for displaying an image). In certain embodiments, the scanner controller 16, controller 18, operator workstation 20, and image display workstation 22 may be combined into a single unit or device or fewer units or devices.

The scanner controller 16, which is coupled to the detector 12, may be coupled to the controller 18 to enable the controller 18 to control operation of the scanner controller 16. Alternatively, the scanner controller 16 may be coupled to the operator workstation 20 which controls the operation of the scanner controller 16. In operation, the controller 18 and/or the workstation 20 controls the real-time operation of the PET system or SPECT system 10. In certain embodiments the controller 18 and/or the workstation 20 may control the real-time operation of another imaging modality (e.g., the CT imaging system in FIG. 2) to enable the simultaneous and/or separate acquisition of image data from the different imaging modalities. One or more of the scanner controller 16, the controller 18, and/or the operation workstation 20 may include a processor 24 and/or memory 26. In certain embodiments, the PET or SPECT system 10 may include a separate memory 28. The detector 12, scanner controller 16, the controller 18, and/or the operation workstation 20 may include detector acquisition circuitry for acquiring image data from the detector 12, image reconstruction and processing circuitry for image processing in accordance with the presently disclosed approaches. The circuitry may include specially programmed hardware, memory, and/or processors.

The processor 24 may include multiple microprocessors, one or more “general-purpose” microprocessors, one or more special-purpose microprocessors, and/or one or more application specific integrated circuits (ASICS), system-on-chip (SoC) device, or some other processor configuration. For example, the processor 24 may include one or more reduced instruction set (RISC) processors or complex instruction set (CISC) processors. The processor 24 may execute instructions to carry out the operation of the PET or SPECT system 10, such as to perform alignment correction as discussed herein. These instructions may be encoded in programs or code stored in a tangible non-transitory computer-readable medium (e.g., an optical disc, solid state device, chip, firmware, etc.) such as the memory 26, 28. In certain embodiments, the memory 26 may be wholly or partially removable from the controller 16, 18.

As mentioned above, the PET or SPECT system 10 may be incorporated into a dual-modality imaging system such as the PET/CT imaging system 30 in FIG. 2. Referring now to FIG. 2, the PET/CT imaging system 30 includes a PET system 10 and a CT system 32 positioned in fixed relationship to one another. The PET system 10 and CT system 32 are aligned to allow for translation of a patient. In use, a patient is moved through a bore 34 of the PET/CT imaging system 30 to image a region of interest of the patient as is known in the art.

The PET system 10 includes a gantry 36 that is configured to support a full ring annular detector array 12 thereon (e.g., including the plurality of detector assemblies 14 in FIG. 1). The detector array 12 is positioned around the central opening/bore 34 and can be controlled to perform a normal “emission scan” in which positron annihilation events are counted. To this end, the detectors 14 forming array 12 generally generate intensity output signals corresponding to each annihilation photon.

The CT system 32 includes a rotatable gantry 38 having an X-ray source 40 thereon that projects a beam of X-rays toward a detector assembly 42 on the opposite side of the gantry 38. The detector assembly 42 senses the projected X-rays that pass through a patient and measures the intensity of an impinging X-ray beam and hence the attenuated beam as it passes through the patient. During a scan to acquire X-ray projection data, gantry 38 and the components mounted thereon rotate about a center of rotation. In certain embodiments, the CT system 32 may be controlled by the controller 18 and/or operator workstation 20 described in FIG. 2. In certain embodiments, the PET system 10 and the CT system 32 may share a single gantry. Image data may be acquired simultaneously and/or separately with the PET system 10 and the CT system 32.

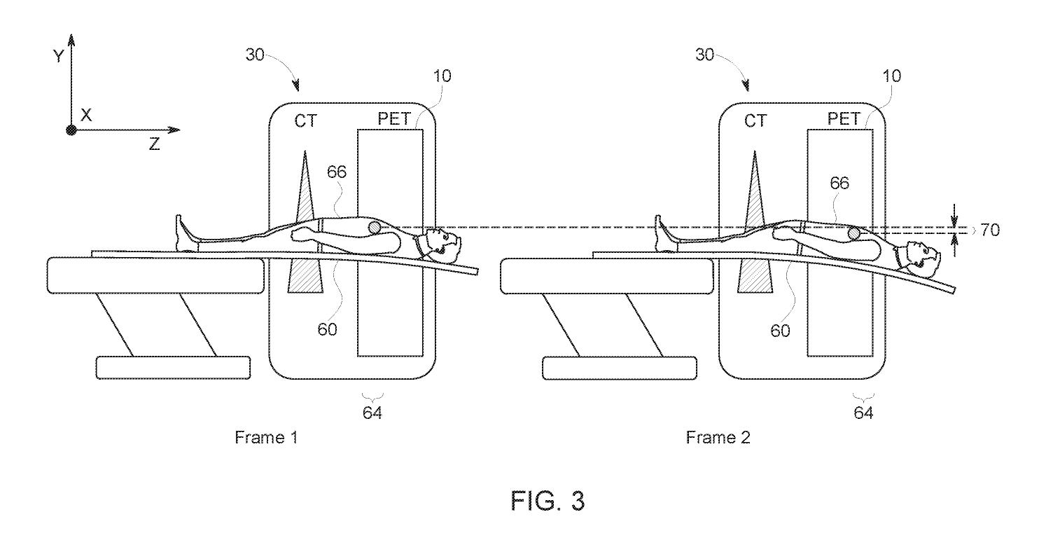

As previously noted, the present approach is directed to addressing the consequences of deflection of a patient support as the patient 62 is moved through the imaging bore of the imaging system(s) 10, 30. An example of this phenomena is graphically illustrated in FIG. 3. As shown in FIG. 3, the patient cradle 60 may bend downwards, i.e., deflect, when a heavy patient 62 lies on the patient cradle 60. As the cradle 60 extends further in a multiple-frame scan it deflects further in later scans (i.e., scans in which the cradle 60 is further extended). As shown in FIG. 3 in the context of a PET scan, an overlap region 64 may be present between two frames, here shown as a Frame 1 acquisition on the left and a Frame 2 acquisition on the right. To facilitate visualization, the overlap region 64 is illustrated as including a feature 66, e.g., an anatomic or structural feature or fiducial marker that will be visible on the inferior region (i.e., toward the feet of the patient) of the scan acquired at Frame 1 and on the superior region (i.e., toward the head of the patient) of the scan acquired at Frame 2. As seen in this example, the greater deflection of the cradle 60 at Frame 2 results in a vertical displacement 70 of the feature 66 in the two images.

The images from adjacent PET frames are stitched together after the PET image reconstruction at the overlap region 64 to form a composite image frame. Since the feature 66 is present in the overlap region 64 between the two frames, stitching of these two frames results in mis-registration of the feature 66. If the amount of the mis-registration is greater than the full width at half maximum (FWHM) of the feature's intensity profile, the feature 66 will appear to be two separate features, which can deteriorate the quality of the medical images.

As discussed herein, if the magnitudes of misalignment between adjacent PET frames in the overlap region 64 is known, the misalignment (i.e., vertical displacement 70) can be reduced through post-reconstruction processing. For example, in one implementation misalignment in the overlap region between adjacent PET frames is compensated by performing a post-reconstruction interpolation as discussed in greater detail below. Further, based on the approach discussed herein, misalignment between adjacent PET frames in the overlap region 64 can be pre-calibrated using the empirical methods.

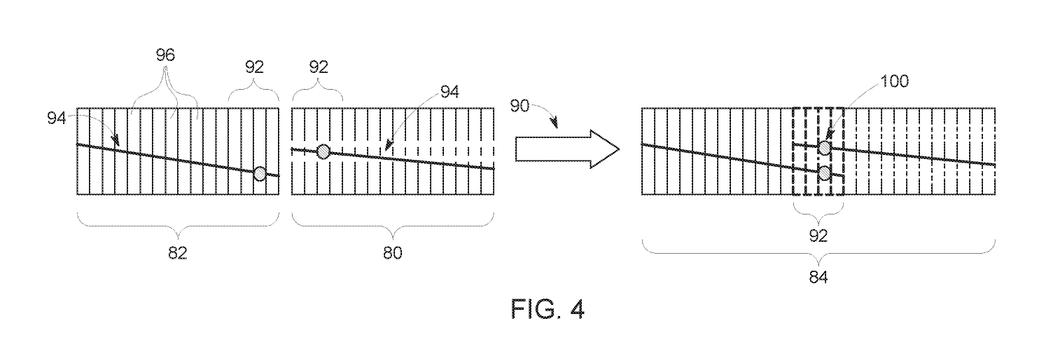

With the preceding in mind, and turning to FIG. 4, an example of a process flow is illustrated corresponding to stitching (step 90) two PET image frames (first PET Frame 80 and second PET frame 82) together without the benefit of the present interpolation approach to form a composite, i.e., stitched. PET frame 84. As shown, each image frame 80, 82 includes multiple (here sixteen) axial slices 96 and the patient position in each slice 96, such as along the major axis of the patient, is represented by line 94. As previously noted, an overlap region 92 may exist in each frame where the slices 96 in the overlap region 92 correspond to the same portion of patient anatomy (i.e., the same anatomic region of the patient is imaged in both frames, though at different “ends” (i.e., superior and inferior directions) of the respective frames. In practice, the frames 80, 82 may be stitched together at the overlap region to make a continuous image.

As noted above, for other image frames (here the second PET frame 82) the patient support may be further extended and therefore further deflected. This can be seen visually in the depicted frames 80, 82 by the greater slope observed in the patient position line or axis 94 in the second frame 82 relative to the first frame 80. Further, as can be seen in the first PET frame 80 and second PET frame 82, the patient position line or axis 94 in the overlap region 92 does not align due to the increased deflection of the patient support between the frames 80, 82. As a consequence, when the first PET frame 80 and second PET frame 82 are stitched together at the overlap region 92, the patient position is mis-registered (i.e., mis-aligned). Because of this, a single feature in the overlap region 92 may appear as two separate and distinct features 100 in the stitched PET frame 84.

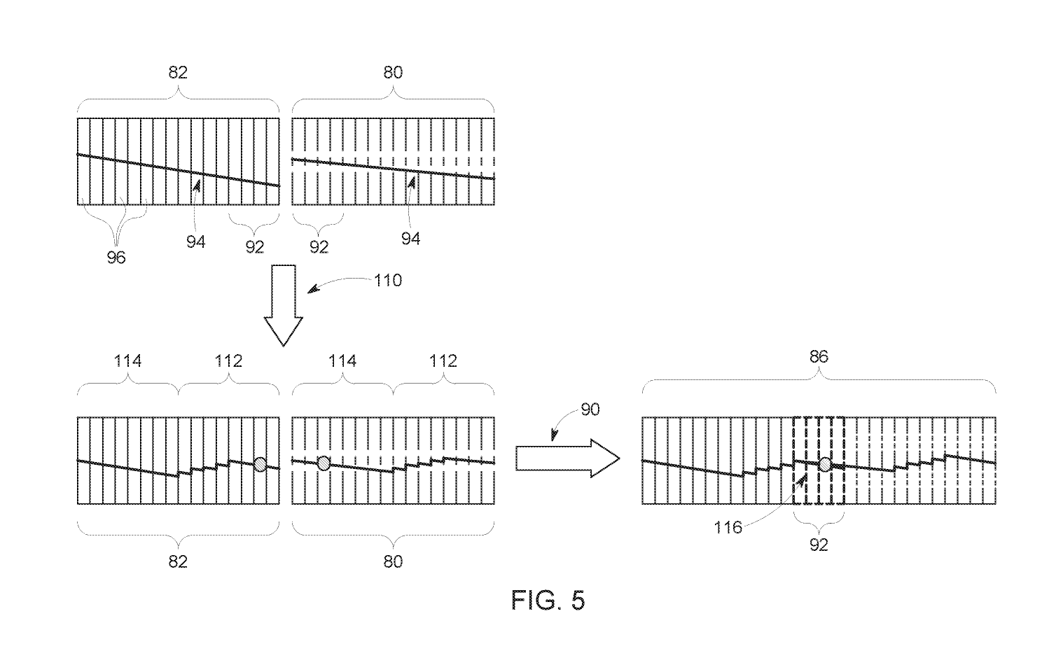

Conversely, turning to FIG. 5, in accordance with the present approach, after PET image reconstruction for a frame is finished, the end that is on the superior side of the scanner axis is interpolated (step 110) to shift the centroid upwards to compensate for the downward deflection of the cradle 60. The end that is on the inferior side of the scanner axis is not interpolated. In the depicted example, this is illustrated by the half of the slices (i.e., slices 96) of each frame 80, 82 in the superior direction being interpolated (interpolated slices 112) and the other half of the slices of each frame 80, 82 in the inferior direction not being interpolated (un-interpolated slices 114). As a consequence of this interpolation, when the first PET frame 80 and second PET frame 82 are stitched together at the overlap region 92 to produce an interpolated stitched frame 86, the patient position is registered (i.e., aligned) within the overlap region. Because of this, a single feature in the overlap region 92 is correctly displayed as a single feature 116 in the interpolated stitched PET frame 86.

In the depicted example, the interpolation is only in the vertical (y) direction. In one implementation, all the pixels within each slice 96 are interpolated by the same amount. However, the magnitude of interpolation from slice to slice may vary. For example, the change in the magnitude of interpolation from slice to slice may be given by the equation:

$$\begin{matrix}0 & ( z \leq {z}_{1} ) \\ {d}_{z} = \frac{z - {z}_{1}}{{z}_{2} - {z}_{1}} \times d & ( z > {z}_{1} ⋂ z < {z}_{2} ) \\ d & ( z \geq {z}_{2} )\end{matrix} \qquad ( 1 )$$

where z is the axial slice number in each PET frame, zi is the slice number of the middle slice in a PET frame, z₂ is the slice number of the first slice in the PET frame overlap region 92, d_{z} is the magnitude of interpolation for slice z, d is the maximum amount of interpolation for each frame. The value of d may be pre-determined from table calibration in certain embodiments.

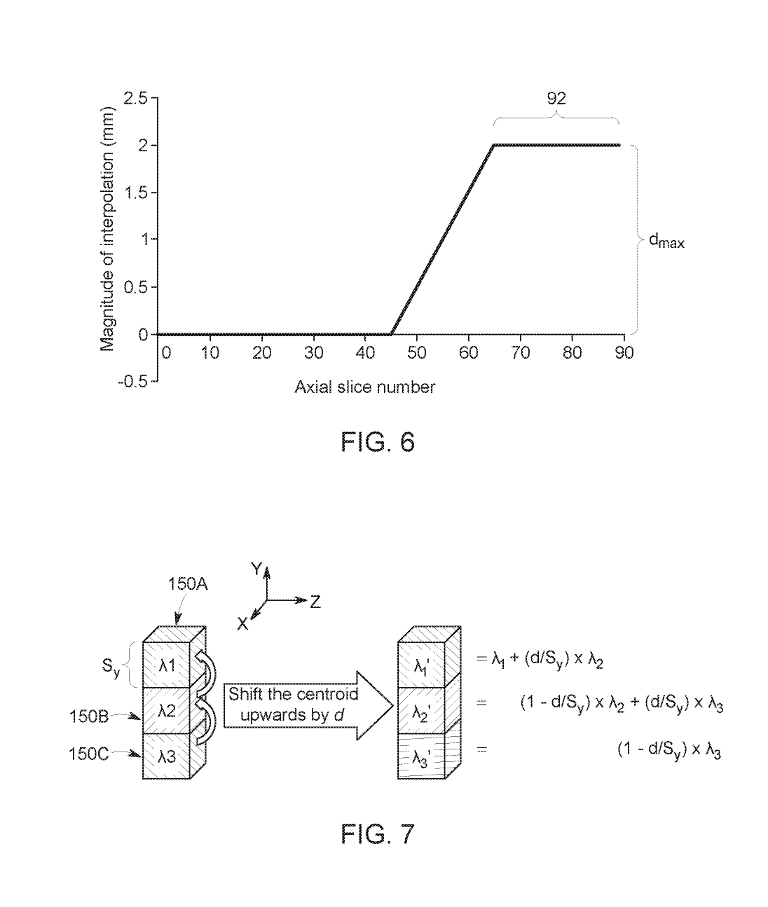

In one implementation, the magnitude of interpolation is 0 (i.e., no interpolation) for the slices that are on the inferior side of the gantry, and increases from the middle slice linearly towards the maximum amount at the slice number z₂, which is the first slice of the overlap region. This linear increase in the non-overlap region helps to avoid step changes of feature locations between the overlap region 92 and the non-overlap region. In one such example, the magnitude of interpolation is constant in the overlap region 92. This function is illustrated graphically in FIG. 6, wherein interpolation is held constant in the overlap region at d=2 mm. Thus, in this example, interpolation begins at the middle slice of the frame (i.e., ˜axial slice 45) at which point interpolation increases linearly from 0 to the maximum interpolation (here 2 mm) at the start of the overlap region 92. Within the overlap region 92 the maximum interpolation is applied uniformly. Though a linear interpolation is discussed as an example herein to facilitate explanation, it should be appreciated that in other embodiments, a non-linear interpolation may instead be performed.

In one embodiment, within each slice 96 to which interpolation is applied (i.e., interpolated slices 112) the interpolation is a 1-dimensional linear interpolation that shifts the centroid of the image upwards in the y-dimension by d_{z}. The linear interpolation method is illustrated in FIG. 7 with respect to three pixels 150A, 150B, and 150C in an adjacent and linear relationship to one another in the y-dimension. Visually, to shift the centroid of the image upwards by d_{z}, a fraction of the image intensity from each pixel 150 is added to the pixel above it. The fraction, for a given pixel in a respective slice 96, is the ratio of d over S_{y}, where S_{y} is the size of the pixel 150 in the vertical direction and d is the magnitude of interpolation such that d<S_{y}. In this example, if d_{z} is greater than S_{y}, all the pixels are first shifted upwards by n whole pixels such that d_{z}−n×S_{y}<S_{y}. For those pixels 150 outside of the image reconstruction field of view (FOV), the image intensity of the pixels just inside the image FOV is duplicated to allow image interpolation for the pixels on the edge of the image FOV.

Thus, in the example, show in FIG. 7, the lowermost pixel 150C in the y-dimension has an initial intensity of λ₃, the middle pixel 150B has an initial intensity of λ₂, and the topmost pixel 150A has an initial intensity of λ₁, To visually shift the centroid upward as discussed herein so as to correct for deflection of the patient support, the interpolated lowermost pixel intensity is λ′₃=(1−d/S_{y})×λ₃; the interpolated middle pixel intensity is λ′₂=(1−d/S_{y})×λ₂+(d/S_{y})×λ₃; the interpolated topmost pixel intensity is λ′₁=λ₁+(d/S_{y})×λ₂.

Technical effects of the invention include correcting for misalignment in an overlap region between adjacent frames of a set of scan data. By way of example, a system and method for applying a post-reconstruction interpolation are described to correct mis-registration of features within the overlap region. In one implementation, the interpolation is a linear interpolation that is performed once, so the impact on image reconstruction speed is minimal. Though the present discussion and examples are generally presented in the context of a sequential axial frame acquisitions, the present approach may be equally applicable in a single scan context, such as where an acquisition is performed while slowly extending the patient support within the imaging bore of a scanner such that support deflection increases over the course of the acquisition.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for correcting mis-alignment of image data, comprising:
accessing two or more reconstructed image frames, wherein adjacent image frames each have an overlap region corresponding to a respective region of a patient, wherein for a respective pair of adjacent image frames the respective region is vertically displaced between a first image frame and a second image frame of the respective pair;
performing an interpolation of a subset of each reconstructed image frame such that each frame comprises an interpolated region and a non-interpolated region, wherein the interpolated region of the second image frame includes the overlap region and the non-interpolated region of the first image frame includes the overlap region; and
joining the first image frame and the second image frame at the overlap region to form an interpolated composite frame, wherein the vertical displacement of the respective region is at least partially corrected in the interpolated composite frame.

2. The method of claim 1, wherein each frame comprises a plurality of axial slices.

3. The method of claim 1, wherein the interpolation is performed on half of each image frame.

4. The method of claim 1, wherein the overlap region in the second image frame is a subset of the interpolated region.

5. The method of claim 1, wherein the interpolated region of each frame is in the superior direction relative to the patient and the non-interpolated region of each frame is in the inferior direction relative to the patient.

6. The method of claim 1, wherein the interpolation shifts an intensity centroid upward in a vertical dimension in pixels within the interpolated region.

7. The method of claim 1, wherein the interpolation is a one-dimensional linear interpolation.

8. The method of claim 1, wherein a magnitude of the interpolation within the interpolated region is the same within each slice such that all pixels within a given slice are interpolated the same amount but the magnitude of the interpolation between slices differs for at least a portion of the slices in the interpolated region.

9. The method of claim 1, wherein the magnitude of the interpolation from slice to slice within a respective image frame is based on the equation:
$$\begin{matrix}0 & ( z \leq {z}_{1} ) \\ {d}_{z} = \frac{z - {z}_{1}}{{z}_{2} - {z}_{1}} \times d & ( z > {z}_{1} ⋂ z < {z}_{2} ) \\ d & ( z \geq {z}_{2} )\end{matrix}$$

10. The method of claim 1, wherein the maximum interpolation is applied throughout the overlap region, no interpolation is applied within the non-interpolated region, and between the overlap region and the non-interpolated region the magnitude of interpolation is between zero and the maximum interpolation.

11. An image processing system, comprising:
a processor configured to access or generate two or more reconstructed image frames and to execute one or more executable routines for processing the two or more reconstructed image frames; and
a memory configured to store the one or more executable routines, wherein the one or more executable routines, when executed by the processor, cause the processor to:
access the two or more reconstructed image frames, wherein adjacent image frames each have an overlap region corresponding to a respective region of a patient, wherein for a respective pair of adjacent image frames the respective region is vertically displaced between a first image frame and a second image frame of the respective pair;
perform an interpolation of a subset of each reconstructed image frame such that each frame comprises an interpolated region and a non-interpolated region, wherein the interpolated region of the second image frame includes the overlap region and the non-interpolated region of the first image frame includes the overlap region; and
join the first image frame and the second image frame at the overlap region to form an interpolated composite frame, wherein the vertical displacement of the respective region is at least partially corrected in the interpolated composite frame.

12. The image processing system of claim 11, wherein the overlap region in the second image frame is a subset of the interpolated region.

13. The image processing system of claim 11, wherein the interpolation comprises a one-dimensional linear interpolation.

14. The image processing system of claim 11, wherein the interpolation shifts an intensity centroid upward in a vertical dimension in pixels within the interpolated region.

15. The image processing system of claim 11, wherein a magnitude of the interpolation within the interpolated region is the same within each slice such that all pixels within a given slice are interpolated the same amount but the magnitude of the interpolation between slices differs for at least a portion of the slices in the interpolated region.

16. The image processing system of claim 11, wherein the maximum interpolation is applied throughout the overlap region, no interpolation is applied within the non-interpolated region, and between the overlap region and the non-interpolated region the magnitude of interpolation is between zero and the maximum interpolation.

17. One or more non-transitory computer-readable media encoding executable routines, wherein the routines, when executed by a processor, cause acts to be performed comprising:
accessing two or more reconstructed image frames, wherein adjacent image frames each have an overlap region corresponding to a respective region of a patient, wherein for a respective pair of adjacent image frames the respective region is vertically displaced between a first image frame and a second image frame of the respective pair;
performing an interpolation of a subset of each reconstructed image frame such that each frame comprises an interpolated region and a non-interpolated region, wherein the interpolated region of the second image frame includes the overlap region and the non-interpolated region of the first image frame includes the overlap region; and
joining the first image frame and the second image frame at the overlap region to form an interpolated composite frame, wherein the vertical displacement of the respective region is at least partially corrected in the interpolated composite frame.

18. The one or more non-transitory computer-readable media of claim 17, wherein the overlap region in the second image frame is a subset of the interpolated region.

19. The one or more non-transitory computer-readable media of claim 17, wherein the interpolation comprises a one-dimensional linear interpolation.

20. The one or more non-transitory computer-readable media of claim 17, wherein the maximum interpolation is applied throughout the overlap region, no interpolation is applied within the non-interpolated region, and between the overlap region and the non-interpolated region the magnitude of interpolation is between zero and the maximum interpolation.
